(19) United States
(12) Patent Application Publication
(10) Pub. No.: US 2007/0063863 A1
(43) Pub. Date: Mar. 22, 2007

(54) Remote controller

(75) Inventors: Hsi-Tsung Cheng, Chung Ho City (TW); Chien-Fa Chen, Chung Ho City (TW); Chi-Hsien Shih, Chung Ho City (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: AverMedia Technologies, Inc., Chung Ho City (TW)

(21) Appl. No.: 11/329,318

(22) Filed: Jan. 10, 2006

(30) Foreign Application Priority Data
Sep. 20, 2005 (TW) 094132499

(51) Int. Cl. H02J 13/00

(52) U.S. Cl. 340/825.69; 340/825.52

(57) ABSTRACT

A remote controller is described. The remote controller can remote control a plurality of electrical equipments, e.g. digital video recorders, simultaneously or respectively. The remote controller includes a signal emitter, a memory, and a plurality of keys. The memory stores a plurality of controller identification codes, and the keys can select at least one of the controller identification codes and the same is sent to the electrical equipments through the signal emitter. The electrical equipment compares the controller identification code with an equipment identification code stored in the electrical equipment when the electrical equipment receives the controller identification code. If the controller identification code corresponds to the equipment identification code, the electrical equipment executes subsequent commands from the remote controller, and if the controller identification code does not correspond to the equipment identification code, the electrical equipment refuses to execute the subsequent commands from the remote controller.

### RELATED APPLICATIONS

The present application is based on, and claims priority from, Taiwan Application Serial Number 94132499, filed Sep. 20, 2005, the disclosure of which is hereby incorporated by reference herein in its entirety.

### BACKGROUND

1. Field of Invention

The present invention relates to a remote controller. More particularly, the present invention relates to a remote controller that can simultaneously remote control a plurality of electrical equipments.

2. Description of Related Art

As the technology progress day by day, all kinds of electrical equipments gradually becomes technologize. These electrical equipments with technologize enter every family and every place due to its favorable price, stronger functions and humanize operations. In the operation of electrical equipment with technologize, for example, a remote controller has already become a necessary device. However, as the advance of the technology, the function of the electrical equipment is greatly enhanced and varied, so that there are more different remote controllers corresponding to respective electrical equipments. At the present day, the manner for controlling respective electrical equipments, e.g. an air conditioner, a television, a DVD player, a digital video recorder (DVR) or an audio apparatus etc., are use an exclusive remote controller. Therefore, as the kind or quantity of the electrical equipments increase, the quantity of the remote controllers will be increased greatly.

Once a large number of remote controllers exist, not only the inconvenience would be produced during the operation, but also the interference from identical remote controllers would be occurred due to their identical frequency and command.

For example, in the case of a DVR frequently used to monitor a building, as the height of the building raise, the number of the entrances would be also increased, thus the quantity of the DVRs used to monitor and record would be increased. When a lot of DVRs simultaneously to be placed on a same location, a guarder need to use various remote controllers in order to control these DVRs. However, various remote controllers will result in the interference between each other. We can use a design of hardware so that the frequency or signal will not interfere with each other. According to the solution of the design of hardware in above, it not only will result in the cost to be increased, but also the user need to independently remote control each DVR, therefore, it is time-consuming and the object of monitoring immediately could not be achieved.

### SUMMARY

As described in above prior art, in case of a large number of conventional remote controllers are used simultaneously, not only the inconvenience would be produced during the operation but the interference from frequencies and commands emitted from the conventional remote controllers would be occurred, when identical electrical equipments are present.

It is therefore an objective of the present invention to provide a remote controller for simultaneously controlling a plurality of electrical equipments so that the quantity of the remote controllers can be reduced.

It is another objective of the present invention to provide a remote controller and electrical equipments, a single remote controller can remote control a plurality of electrical equipments simultaneously or respectively through the setup of the software, so that the interference from identical remote controllers can be avoided.

It is another objective of the present invention to provide a remote controller and DVRs, each DVR can be set to have an identification code through the setup of software while the remote controller can control and operate an assigned DVR.

According to the foregoing objectives of the invention, a remote controller is provided. The remote controller of the present invention is able to operate an electrical equipment having an equipment identification code set through software. The remote controller includes a signal emitter, a memory and a plurality of keys. The memory stores a plurality of controller identification codes, the keys can select at least one of the controller identification codes and the same is sent to the electrical equipments through the signal emitter.

The electrical equipment compares the controller identification code with an equipment identification code stored in the electrical equipment when the electrical equipment receives the controller identification code. If the controller identification code corresponds to the equipment identification code, the electrical equipment executes subsequent commands from the remote controller, and if the controller identification code does not correspond to the equipment identification code, the electrical equipment refuses to execute the subsequent commands from the remote controller. The controller identification code at least comprises a single identification code, a group identification code and a general identification code. The single identification code is consists of a sequence code and the group identification code is consists of a group code and a sequence code. The remote controller can simultaneously remote control a plurality of electrical equipments by using the general identification code. The electrical equipment preferably is a digital video recorder.

Another purpose of the present invention is to provide a method for remote controlling a electrical equipment, comprises the steps of setting a equipment identification code into the electrical equipment, emitting a controller identification code through a remote controller, comparing the equipment identification code with the controller identification code, the electrical equipment executes subsequent commands from the remote controller if the equipment identification code corresponds to the controller identification code and the electrical equipment refuses to execute the subsequent commands from the remote controller if the equipment identification code does not correspond to the controller identification code.

The method further comprises the electrical equipment executes subsequent commands from the remote controller until the electrical equipment receives another controller identification not corresponding to the equipment identification code.

According to the remote controller and the electrical equipment controlled by the remote controller of the present invention, the electrical equipment preferably is a DVR, a single remote controller could be used to simultaneously remote control a plurality of electrical equipments, so that not only the quantity of the remote controllers can be reduced but also the interference from identical remote controller can be avoided without increasing the signal emitters having different frequencies. Therefore, the remote controller and the electrical equipments of the present invention can be set to have a respective identification code through software, so that the remote controller can remote control the electrical equipments, meanwhile, the quantity of the electrical equipments can be set in turn according to user's request while not limited to the limitation of hardware and cost of the signal emitter of the remote controller and the signal receivers of the electrical equipments. Furthermore, as soon as the remote controller of the present invention emits an equipment identification code through the key thereof in the operation, similar to a conventional remote controller, the remote controller of the present invention is able to remote control the selected electrical equipments. Therefore, according to the present invention, not only the cost of the electrical equipments and the remote controller can be reduced greatly, but also the user can only use a single remote controller to operate a plurality of electrical equipments.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is one preferred embodiment of the present invention that uses a remote controller of the present invention to control an operation of a plurality of DVRs;

FIG. 2 is a flowchart that uses a remote controller of the present invention to control an operation of a plurality of DVRs;

FIG. 3A is a block diagram illustrating a DVR according to a preferred embodiment of the present invention; and

FIG. 3B is a block diagram illustrating a remote controller according to a preferred embodiment of the present invention.

### DESCRIPTION OF THE PREFERRED EMBODIMENTS

The remote controller of the present invention can simultaneously control a plurality of electrical equipments, so that the quantity of the remote controllers can be reduced. Furthermore, according to the present invention, a single remote controller can remote control a plurality of electrical equipments simultaneously or respectively through the setup of the software identification codes of the electrical equipments, so that the interference from identical remote controllers can be avoided and the quantity of the signal emitters having different frequencies can be reduced. Accordingly, the remote controller of the present invention can simultaneously or respectively remote control a plurality of electrical equipments by using identical frequency and hardware, so that the cost of the remote controllers can be decreased effectively and the quantity of the remote controllers can be reduced greatly. Furthermore, because the identification codes are set through software, the quantity of the controlled electrical equipments could be set according to a requirement while not limited to the limitation of hardware and cost of the signal emitters. The spirit of the present invention will become better understood with regard to the accompanying drawings and the following description and it will be apparent to those skilled in the art that various modifications and variations can be made to the structure of the present invention without departing from the scope and spirit of the invention.

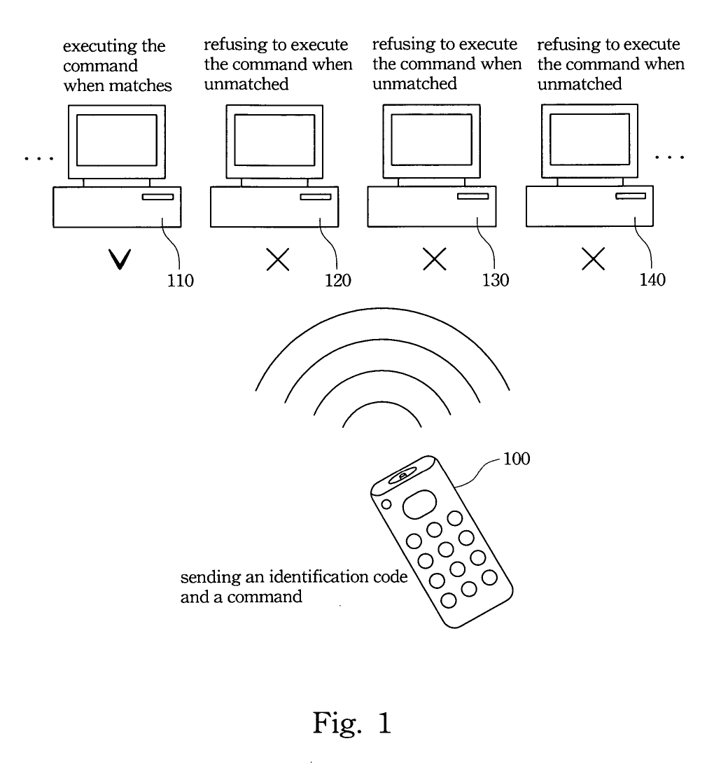

Referring to FIG. 1, which is one preferred embodiment of the present invention that uses a remote controller of the present invention to control an operation of a plurality of DVRs. As shown in the diagram, a remote controller 100 can remote control a first DVR 110, a second DVR 120, a third DVR 130 and a fourth DVR 140 simultaneously and respectively.

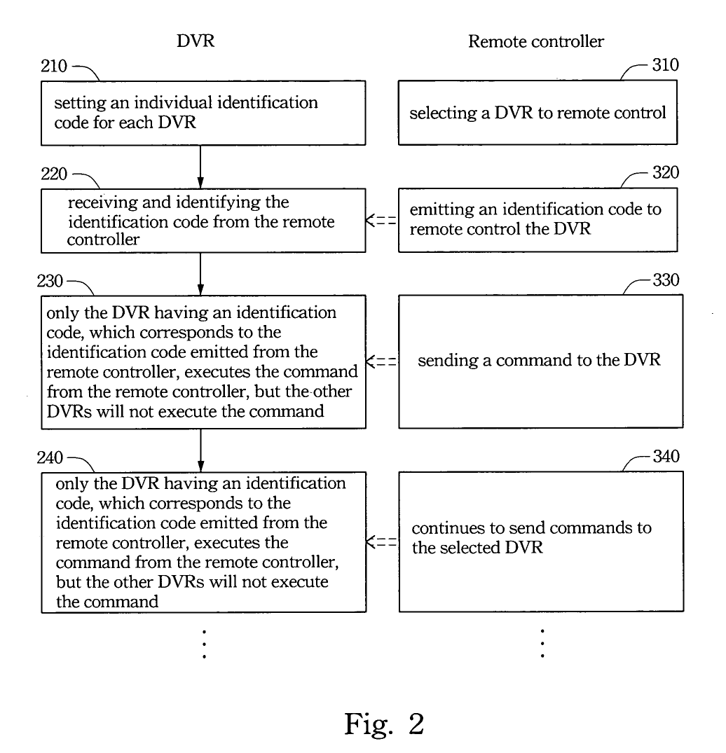

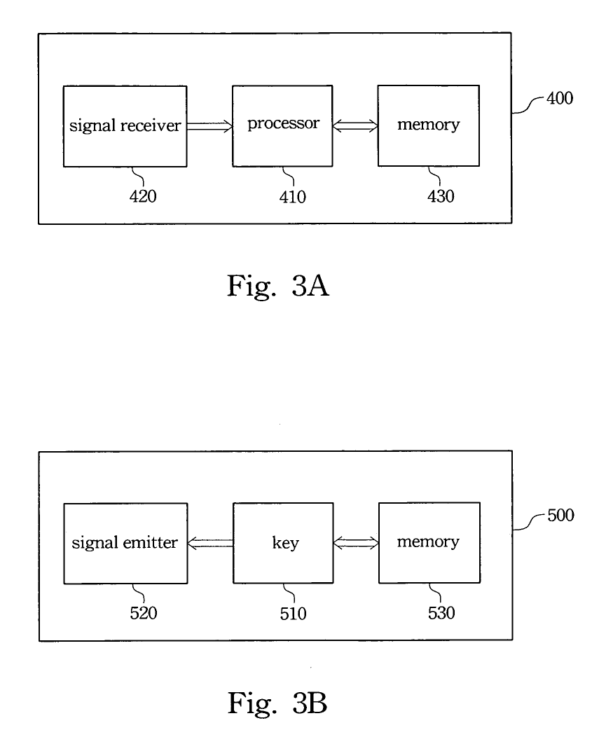

Referring to FIG. 2, FIG. 3A and FIG. 3B, wherein FIG. 2 is a flowchart that uses a remote controller of the present invention to control an operation of a plurality of DVRs, FIG. 3A is a block diagram illustrating a DVR according to a preferred embodiment of the present invention and FIG. 3B is a block diagram illustrating a remote controller according to a preferred embodiment of the present invention. In FIG. 3A, each DVR 400 at least includes a processor 410, a signal receiver 420 and a memory 430. In FIG. 3B, a remote controller 500 at least includes a plurality of keys 510, a signal emitter 520 and a memory 530.

When the memory 430 of the DVR 400 is powered on, a group of identification codes can be stored into the memory 430 through the setup of software, such as DVR1, DVR2, DVR3 or DVR4, or Arabic numerals 1, 2, 3 or 4, in order to identify different DVRs. In FIG. 1, for example, an identification code of the first DVR 110 is set to DVR1, an identification code of the second DVR 120 is set to DVR2, an identification code of the third DVR 130 is set to DVR3 and an identification code of the fourth DVR 140 is set to DVR4.

Furthermore, the memory of the remote controller 500 stores a plurality of corresponding identification codes, and the remote controller 500 can emit a corresponding identification code through the signal emitter 520 by the keys 510, wherein the method for emitting the corresponding identification code includes uses a single key or a combined keys. When the signal emitter 520 of the DVR 400 receives the identification code from the remote controller 500, then the processor 410 compares the identification code with an identification code stored in the memory 430. If the result of comparison matches, the DVR 400 continues to receive and execute subsequent commands from the remote controller 500.

As shown in FIG. 2, first in step 210, sets an individual identification code for each DVR. In step 310, when the identification codes of the DVRs are set, a user can use a remote controller to select and operate a DVR which he/she want to remote control. It has been noted, different DVRs could be set to have identical identification code, e.g. these DVRs have an identification code which is set to 1; or, each DVR has an identification code different from each other, e.g. each DVR's identification code is in turn set to 1, 2, 3 . . . etc; or, these DVRs could be separated into several groups and each group is consist of several DVRs, e.g. a first group is consist of three DVRs having identification codes 10, 11 and 12 respectively while a second group is consist of three DVRs having identification codes 20, 21 and 22 respectively, wherein the identification code of the first group is set to 10 and the identification code of the second group is set to 20, for example. Therefore, the remote controller can emit an identification code such as 1, 11 or 21 to remote control a single DVR or a plurality of DVRs, or the remote controller can emit a group identification code such as 10 or 20 to remote control a group of DVRs, or the remote controller can emit a general identification code such as 0 to remote control whole DVRs.

In step 320, the remote controller emits an identification code to remote control a DVR corresponding to the identification code. At the same time, in step 220, the DVR receives and identifies the identification code. Thereafter, in step 330, the remote controller sends a command to the DVR. In step 230, only the DVR having an identification code, which corresponds to the identification code emitted from the remote controller, executes the command from the remote controller, but the other DVRs will not execute the command. In step 340, the remote controller continues to send a new command to the controlled DVR. Similarly, only the DVR having an identification code, which corresponds to the identification code emitted from the remote controller, executes the command from the remote controller, but the other DVRs will not execute the command, as shown in step 240. When the remote controller sends a new identification code, a DVR having an identification code, which corresponds to the new identification code emitted from the remote controller, executes subsequent commands from the remote controller. Once the identification code of the DVR matches the identification code from the remote controller, the DVR will execute subsequent commands from the remote controller until the remote controller emits a new identification code. Therefore, as soon as the remote controller emits an identification code through the key thereof, the remote controller of the present invention can, similar to a conventional remote controller, remote control the operation of the DVR by using a general format of command without increasing any cost of hardware of the emitter and the receiver.

As described in above, the remote controller of the present invention is able to emit a DVR identification code to start a corresponding DVR so that the DVR can execute subsequent commands from the remote controller, and the remote controller of the present invention is able to remote control a single DVR, a group of DVRs or all of DVRs. Therefore, according to the present invention, a single remote controller can control a plurality of DVRs so that not only the quantity of the remote controller can be reduced greatly but also the interference from different remote controllers can be prevented. Furthermore, the remote controller of the present invention is set through software without increasing the output frequency channels of the signal emitter of the remote controller and the input frequency channels of the signal receiver of the DVR, therefore, the cost of hardware of the remote controllers and DVRs can be decreased so that the entire cost of the DVR can be decreased effectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A remote controller for controlling a electrical equipment having an equipment identification code, comprising:
a signal emitter;
a memory for storing a plurality of controller identification codes; and
a plurality of keys for selecting at least one of the controller identification codes from the memory and the same is sent to the electrical equipments through the signal emitter, wherein the electrical equipment compares the controller identification code with the equipment identification code when the controller identification code is received by the electrical equipment, if the controller identification code corresponds to the equipment identification code, the electrical equipment executes subsequent commands from the remote controller.

2. The remote controller of claim 1, wherein the electrical equipment compares the controller identification code with the equipment identification code when the controller identification code is received by the electrical equipment, if the controller identification code does not correspond to the equipment identification code, the electrical equipment refuses to execute the subsequent commands from the remote controller.

3. The remote controller of claim 1, wherein the controller identification code at least comprises a single identification code, a group identification code and a general identification code.

4. The remote controller of claim 3, wherein the single identification code is consists of a sequence code.

5. The remote controller of claim 3, wherein the group identification code is consists of a group code and a sequence code.

6. The remote controller of claim 3, wherein the remote controller can simultaneously remote control a plurality of electrical equipments by using the general identification code.

7. The remote controller of claim 1, wherein the electrical equipment is a digital video recorder.

8. A electrical equipment, comprising:
a signal receiver for receiving a controller identification code from a remote controller;
a memory for storing at least one equipment identification code, and
a processor for receiving the controller identification code from the signal receiver and comparing the controller identification code with the equipment identification code, if the controller identification code corresponds to the equipment identification code, the electrical equipment executes subsequent commands from the remote controller.

9. The electrical equipment of claim 8, wherein the electrical equipment compares the controller identification code with the equipment identification code when the controller identification code is received by the electrical equipment, if the controller identification code does not correspond to the equipment identification code, the electrical equipment refuses to execute the subsequent commands from the remote controller.

10. The electrical equipment of claim 8, wherein the controller identification code is a single identification code, a group identification code or a general identification code.

11. The electrical equipment of claim 10, wherein the single identification code is consists of a sequence code.

12. The electrical equipment of claim 10, wherein the group identification code is consists of a group code and a sequence code.

13. The electrical equipment of claim 10, wherein the remote controller can simultaneously remote control a plurality of electrical equipments by using the general identification code.

14. The electrical equipment of claim 8, wherein the electrical equipment is a digital video recorder.

15. A method for remote controlling a electrical equipment, comprising:
setting a equipment identification code into the electrical equipment;
emitting a controller identification code through a remote controller;
comparing the equipment identification code with the controller identification code; and
the electrical equipment executes subsequent commands from the remote controller if the equipment identification code corresponds to the controller identification code.

16. The method of claim 15, further comprising:
the electrical equipment refuses to execute the subsequent commands from the remote controller if the equipment identification code does not correspond to the controller identification code,

17. The method of claim 15, further comprising:
the electrical equipment executes subsequent commands from the remote controller until the electrical equipment receives another controller identification not corresponding to the equipment identification code.

18. The method of claim 15, wherein the controller identification code at least comprises a single identification code, a group identification code and a general identification code.

19. The method of claim 18, wherein the single identification code is consists of a sequence code while the group identification code is consists of a group code and a sequence code.

20. The method of claim 15, wherein the electrical equipment is a digital video recorder.
